(19) United States
(12) Patent Application Publication
(10) Pub. No.: US 2022/0253806 A1
(43) Pub. Date: Aug. 11, 2022

(54) CABLE CONNECTION WORK SUPPORT SYSTEM, CABLE CONNECTION WORK SUPPORT METHOD, AND CABLE CONNECTION WORK SUPPORT PROGRAM

(71) Applicant: NEC Corporation, Minato-ku, Tokyo (JP)

(72) Inventor: Masaya YAMAMOTO, Tokyo (JP)

(73) Assignee: NEC Corporation, Minato-ku, Tokyo (JP)

(21) Appl. No.: 17/617,384

(22) PCT Filed: Jun. 10, 2020
(86) PCT No.: PCT/JP2020/022842

§ 371 Date: Dec. 8, 2021

(30) Foreign Application Priority Data
Jun. 11, 2019 (JP) 2019-108335

(51) Int. Cl. G06Q 10/10; G06V 10/74

(52) U.S. Cl. CPC G06Q 10/10; G06V 10/74

(57) ABSTRACT

A cable connection work support system comprises a terminal that takes an image of an end of a cable to be connected and an image of a target apparatus, and a management server that performs individual product identification on the basis of the surface pattern of the cable end photographed by the terminal and transmits work support information based on the result of the individual product identification to the terminal on the basis of predesigned cable connection design information and the image captured by the apparatus.

### FIELD

### Reference to Related Application

The present invention is based upon and claims the benefit of the priority of Japanese patent application No. 2019-108335 filed on Jun. 11, 2019, the disclosure of which is incorporated herein in its entirety by reference thereto.

The present invention relates to a cable connection work support system, cable connection work support method, and cable connection work support program.

### BACKGROUND

Nowadays, in response to a significant increase in online shopping and the widespread use of cloud computing, large-scale systems are increasingly being constructed at facilities of telecommunications carriers and at data centers. Not only does such a system have a large scale, but it also tends to utilize devices from multiple vendors. Therefore, it is necessary to connect a wide variety of equipment.

Further, depending on the product series and year, even the same model or devices by the same manufacturer may have different port specifications (port layout and port description using numbers and letters) when ports are added as options or a corporation is acquired and merged with another. Moreover, the meaning of the descriptive symbols and values of ports may be different for each device manufacturer, making it very difficult for all workers to correctly grasp the specification information of a device when they connect a cable to the device.

In order to address these issues, some advocate automating and streamlining construction work. In the background of this, there is a trend created by “i-Construction,” efforts by the Ministry of Land, Infrastructure, Transport and Tourism to fully utilize ICT in order to improve the productivity of the entire construction production system. For instance, Patent Literature 1 describes a technology utilizing the augmented reality (AR) technique in order to reduce the workload of network system construction. Further, Patent Literature 2 describes construction management using AR technology, and Patent Literature 3 describes as-built inspection using AR technology.
[Patent Literature 1] International Publication Number WO2015/001611A
[Patent Literature 2]

Japanese Patent Kokai Publication No. JP2017-220109A
[Patent Literature 3] Japanese Patent Kokai Publication No. JP2018-124843A

### SUMMARY

The disclosure of each literature cited above is incorporated herein in its entirety by reference thereto. The following analysis is given by the present inventors.

In general, system construction at a telecommunications carrier facility or a data center falls under telecommunications work under the Construction Industry Law since facilities inside the station building must be worked on (drilling, distribution board connection, etc.). Because the work must be done in compliance with the Construction Industry Law, physical work such as equipment installation must be performed by workers from a construction company with a construction permit, instead of relevant personnel from a computer-related company. As a result, the workers from the construction company will connect cables relying on the cable tags and markings at the ends of the cables, referring to cable connection design information (cable accommodation list) prepared by the relevant personnel from the computer-related company.

Moreover, systems for telecommunications carriers or ones at data centers have so many racks, servers, devices, and connection ports, and physical distances between connection points (between buildings or stations, etc.) may be large. In such large-scale cable laying work, permanent cable tags (round tags) T left attached will be an obstacle when the cables are laid under the floor or in the duct. Therefore, temporary markings are sometimes attached during the cable laying work, and they are replaced with permanent cable tags (round tags) T after the cables have been installed.

Further, if the connection points are physically separated, it is obviously impossible to check simultaneously both ends of the cable in work. The mistake in reattaching the cable tag (round tag) T or connecting the cable to a port makes backtracking work harder. For instance, as in Patent Literature 1 mentioned above, a method for reducing the workload by utilizing AR technology has been proposed, however, this technique does not solve the problem caused by attaching a physical marking such as a cable tag to an end of the cable. In other words, if physical markings such as cable tags are replaced before and after the cable laying work, there will still be mistakes by the workers and the workload associated with them. Therefore, it is desirable to appropriately manage both ends of a cable connected to physically distant ports without attaching physical markings such as cable tags to the ends of the cable.

In view of the above problems, it is an object of the present invention to provide a cable connection work support system, cable connection work support method, and cable connection work support program that contribute to reducing the burden on the workers by streamlining cable connection work and improving the work quality.

According to a first aspect of the present invention, there is provided a cable connection work support system comprising a terminal that takes an image of an end of a cable to be connected; and a management server that performs individual product identification on the basis of a pattern on the surface of the end of the cable photographed by the terminal and transmits work support information based on the result of the individual product identification to the terminal.

According to a second aspect, there is provided a cable connection work support method including performing individual product identification on the basis of a pattern on the surface of a cable end photographed by a worker who performs connection work; and presenting work support information based on the result of the individual product identification to the worker.

According to a third aspect, there is provided a cable connection work support program causing a computer to execute a step of receiving an image of the surface pattern of an end of a cable to be connected; a step of performing individual product identification on the basis of the surface pattern of the cable end; and a step of transmitting work support information based on the result of the individual product identification. Further, this program can be stored in a computer-readable storage medium. The storage medium may be non-transient one such as a semiconductor memory, a hard disk, a magnetic recording medium, an optical recording medium, and the like. The present invention can also be realized as a computer program product.

According to each aspect of the present invention, there can be provided a cable connection work support system, cable connection work support method, and cable connection work support program that contribute to reducing the burden on the workers by streamlining cable connection work and improving the work quality.

### BRIEF DESCRIPTION OF DRAWINGS

FIG. 1 is a schematic diagram for explaining a cable connection method of a comparative example.

FIG. 2 is a schematic diagram for explaining the cable connection method of the comparative example.

FIG. 3 is a schematic diagram for explaining the cable connection method of the comparative example.

FIG. 4 is a schematic diagram for explaining the cable connection method of the comparative example.

FIG. 5 is a schematic diagram of a cable connection work support system relating to a first example embodiment.

FIG. 6 is a drawing showing an example of the procedure of a cable connection work support program executed by a management server.

FIG. 7 is a drawing illustrating an example of the hardware configuration of the management server.

FIG. 8 is a schematic diagram of a cable connection work support system relating to a second example embodiment.

FIG. 9 is a drawing showing an example of connection design information (cable accommodation list).

FIG. 10 is a drawing showing the flow of information until the cable accommodating list and an implementation diagram of an apparatus are stored in a data storage.

FIG. 11 is a drawing showing how images of both ends of a cable are taken as a pair.

FIG. 12 is a drawing showing how the cable accommodation list and a pair table are stored in the data storage.

FIG. 13 is a drawing showing the flow of information until the pair table is stored.

FIG. 14 is a drawing illustrating how cables are laid under the floor for each rack housing a target apparatus.

FIG. 15 is a drawing illustrating how an apparatus host name marking is displayed over an image of an actual apparatus.

FIG. 16 is a drawing illustrating how data of a virtual drawing is generated.

FIG. 17 is a drawing showing the flow of information until the data of the virtual drawing is stored in the data storage.

FIG. 18 is a drawing illustrating how virtual marking data is generated.

FIG. 19 is a drawing illustrating how the virtual marking data of a port is displayed superimposed over an apparatus.

FIG. 20 is a drawing showing the flow of information until the virtual marking data is displayed.

FIG. 21 is a drawing illustrating how correct cable connection is confirmed.

FIG. 22 is a drawing showing that information of connection completion is added to the cable connection design information (cable accommodation list).

FIG. 23 is a drawing showing the flow of information until the information of connection completion is registered.

FIG. 24 is a drawing showing how finished work inspection is conducted.

FIG. 25 is a drawing showing the results of inspection added to the cable connection design information (cable accommodation list).

FIG. 26 is a drawing showing the flow of information until the inspection results are added to the cable accommodation list.

FIG. 27 is a drawing showing the flow of information until the inspection results are displayed.

FIG. 28 is a drawing showing a first modified example embodiment.

FIG. 29 is a drawing showing a second modified example embodiment.

### MODES

Example embodiments of the present invention will be described with reference to the drawings. However, the present invention is not limited to the example embodiments described below. Further, in each drawing, the same or corresponding elements are appropriately designated by the same reference signs. It should be noted that the drawings are schematic, and the dimensional relationships and the ratios between the elements may differ from the actual ones. There may also be parts where the dimensional relationships and the ratios between drawings are different.

### Comparative Example

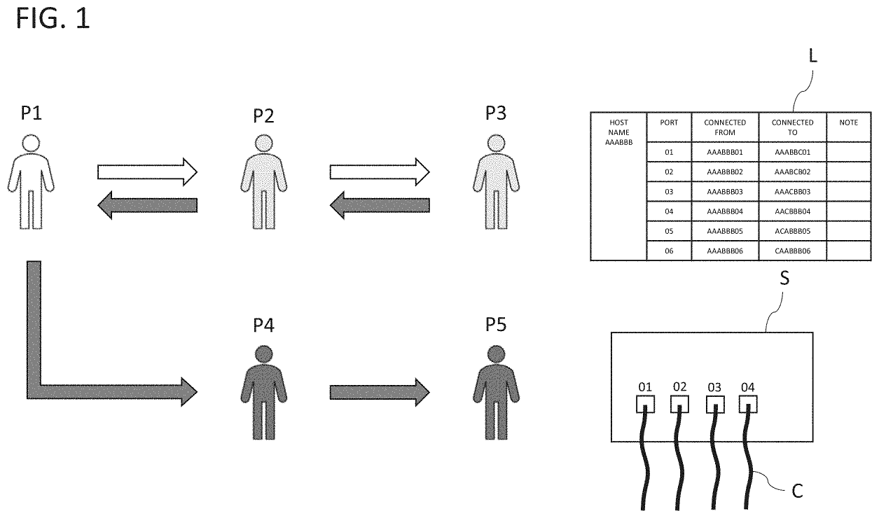

First, a cable connection method will be described as a comparative example in order to clarify the effects of the example embodiments of the present invention. FIGS. 1 to 4 are schematic diagrams for explaining the cable connection method of the comparative example.

As shown in FIG. 1, cable connection in large-scale system construction is performed by two types of personnel; computer-related staff who prepare cable connection design information (cable accommodation list) and personnel who perform the actual cable connection work.

For instance, as shown in FIG. 1, a person P1 of a company that has undertaken the construction of a large-scale system places an order for cable connection design for the system with a representative person P2 of a computer-related company. Then, a person P3 of the computer-related company in charge of cable connection design prepares the cable connection design information (cable accommodation list) L. Meanwhile, the person P1 places an order with a representative person P4 of a construction company for cable connection work according to the prepared cable connection design information (cable accommodation list) L. Then, a worker P5 of the construction company connects cables C to an apparatus S according to the cable connection design information (cable accommodation list) L.

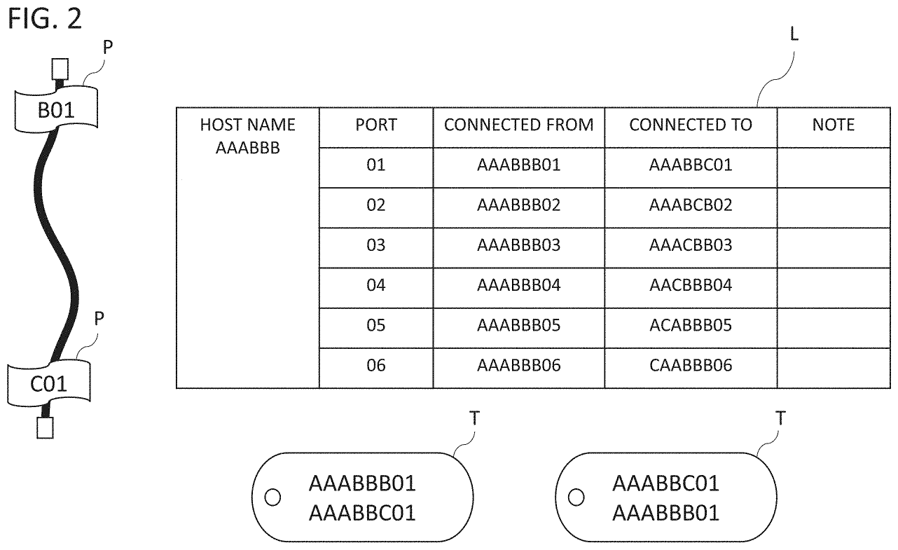

Then, during the cable connection work, the worker P5 of the construction company attaches (numbered) pieces of plastic tape P as temporary markings to both ends of the cable according to the cable connection design information (cable accommodation list) L, as shown in FIG. 2. Meanwhile, the worker P5 prepares permanent cable tags (round tags) T for cable connection management according to the cable connection design information (cable accommodation list) L.

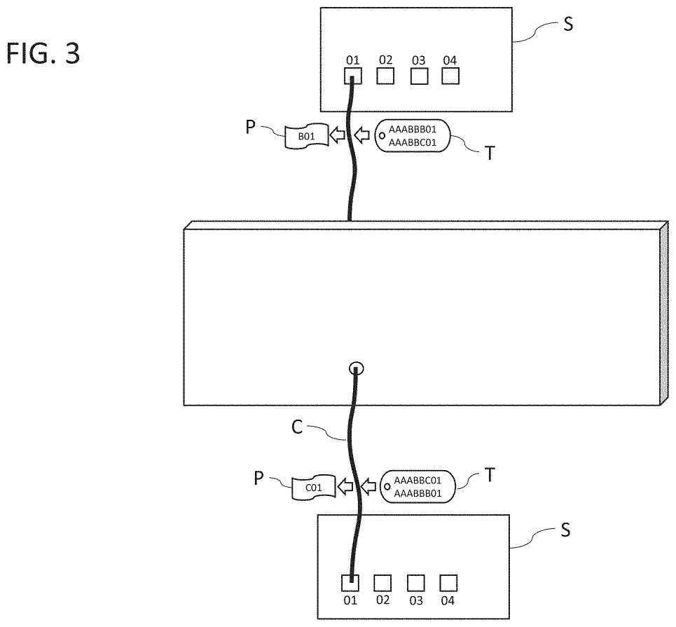

Then, as shown in FIG. 3, the worker P5 installs the cable C, relying on the (numbered) temporary marker plastic tape P and connects the cable C to the ports of the apparatuses S. Next, the worker P5 replaces the (numbered) temporary marker plastic tape P with the permanent cable tags (round tags) T for cable connection management. The reason for this is that, in large-scale system construction, the connection destination of the cable C is often in another room or on another floor, and if the cable tags (round tags) T are used from the beginning, they may touch an existing cable while the worker tries to install the cable under the floor, into a cable shelf on the rack, inside the wall, or under the roof, and this may cause a system failure. The cable tags (round tags) T may also be accidentally detached during the connection work.

As described, the person P3 in charge of cable connection design communicates the details of the work to the worker P5 who performs the actual cable connection work through the cable connection design information (cable accommodation list) L. Therefore, a discrepancy in understanding the cable connection design information (cable accommodation list) L may cause a cable connection mistake. Further, as the scale of the system construction becomes larger, the more workers are involved and the communication system becomes multilayered. As a result, a discrepancy in understanding the cable connection design information (cable accommodation list) L is likely to occur, increasing work omissions and mistakes. Moreover, the possibility widens that mistakes due to handling both the temporary markings P and the permanent cable tags (round tags) T will occur.

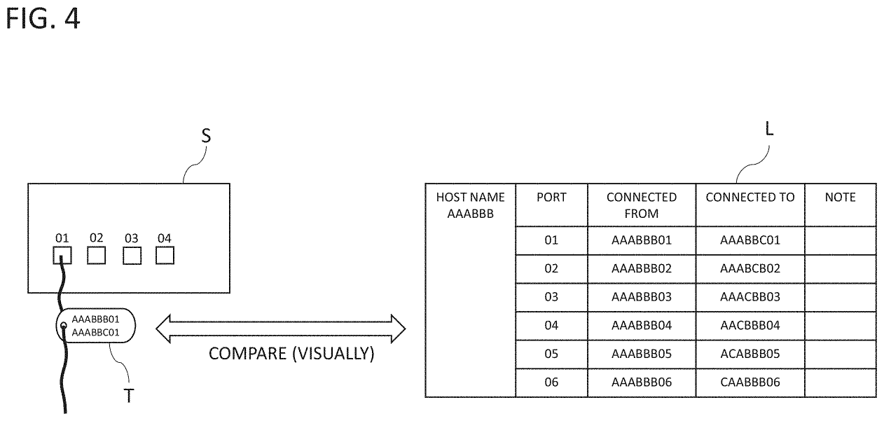

Therefore, after the cables are connected, inspection is performed spending a large number of man-hours. More specifically, as shown in FIG. 4, the cable tag (round tag) T of the cable connected to each port of the apparatus S is visually compared with the cable connection design information (cable accommodation list) L. This visual inspection is performed first within the construction company that performed the cable connection work, another inspection is done in the presence of the prime contractor, and then the same inspection is finally performed in the presence of the party who ordered the system construction, requiring a large number of man-hours.

Further, even if inspection is carried out with a large number of man-hours as described above, human inspection error cannot be completely eliminated since the inspection is performed visually. From a managerial point of view, simply writing down the results of visual inspection on a checklist does not provide validation as to whether the connection is absolutely complete and the inspection results cannot be fed back and utilized for other work.

### First Example Embodiment

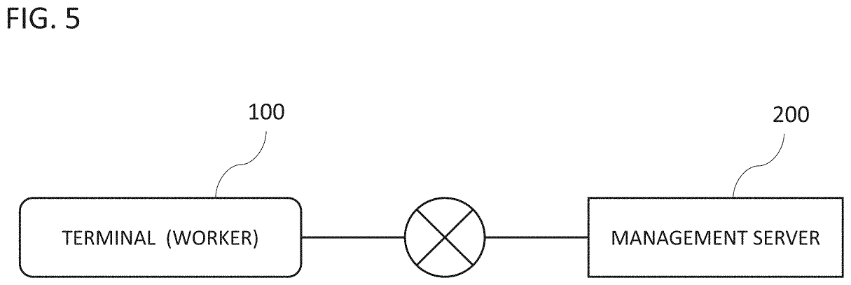

FIG. 5 is a schematic diagram of a cable connection work support system relating to a first example embodiment. As shown in FIG. 5, the cable connection work support system comprises a terminal 100 and a management server 200.

The terminal 100 is a terminal used by a worker who performs cable connection work. In other words, using the terminal 100, the worker takes an image of an end of a cable to be connected. Meanwhile, the management server 200 performs individual product identification on the basis of the pattern on the surface of the end of the cable in the image captured by the worker using the terminal 100 and transmits work support information based on the result thereof to the terminal 100. As a result, the worker who performs the cable connection receives the work support information via the terminal 100 and is able to accurately perform the cable connection work.

Since the cable connection work support system configured as described uses an image of a cable end to identify an individual product, cable connection work can be performed accurately without attaching a physical marking such as a cable tag to the end of the cable. Here, for instance, “object fingerprint authentication” described later may be used for the individual product identification using the image of the cable end. The individual product identification using an image of a cable end eliminates the possibilities of physical makings such as cable tags being an obstacle during cable laying work and of mistakes while the markings are replaced. This can contribute not only to the reduction of man-hours for cable connection work, but also to reliable cable connection.

For instance, the terminal 100 may be a mobile terminal such as a smartphone or tablet comprising a camera function and AR technology. It may also be smart glasses that support AR technology. If AR technology is used, the terminal 100 is able to present to the worker the work support information virtually superimposed over the image of the cable end. It should be noted that the image here also includes an image constituting a frame of a video. In other words, the technology described below can be extended to videos by sequentially processing images in real time.

Note that it is not essential to use the terminal 100 in order to benefit from the effects of the present example embodiment. Using any cable connection work support method that performs individual product identification on the basis of an image of the surface pattern of a cable end captured by the worker performing connection work and that provides the worker with the work support information based on the result of the individual product identification, the worker is able to accurately perform cable connection work without attaching a physical marking such as a cable tag to the cable end. This contributes to the reduction of man-hours for cable connection work.

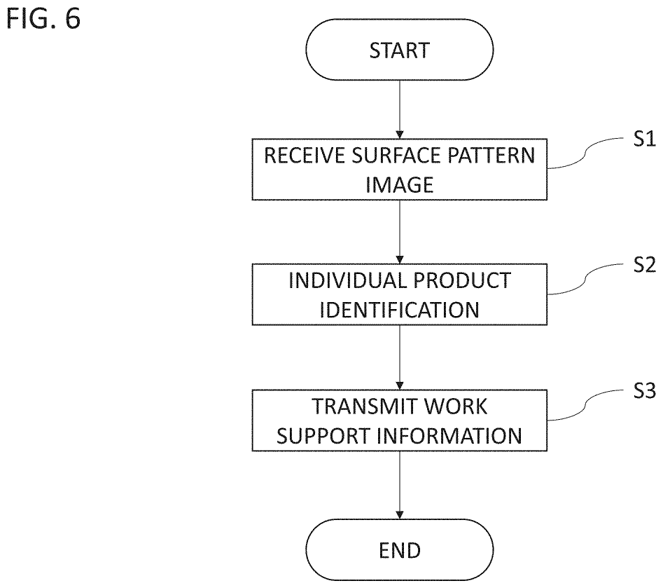

Therefore, for instance, the cable connection work support method of the present example embodiment can be realized as a cable connection work support program executed by the management server 200. FIG. 6 is a drawing showing an example of the procedure of the cable connection work support program executed by the management server. As shown in FIG. 6, the cable connection work support program of the present example embodiment includes step S1 of receiving an image of the surface pattern of an end of the cable to be connected, step S2 of performing individual product identification on the basis of the surface pattern of the cable end, and step S3 of transmitting the work support information based on the result of the individual product identification. By having the management server 200 execute such a cable connection work support program, the worker is able to accurately perform cable connection work without attaching a physical marking such as a cable tag to the end of the cable. This can contribute to the reduction of man-hours for cable connection work and to reliable cable connection.

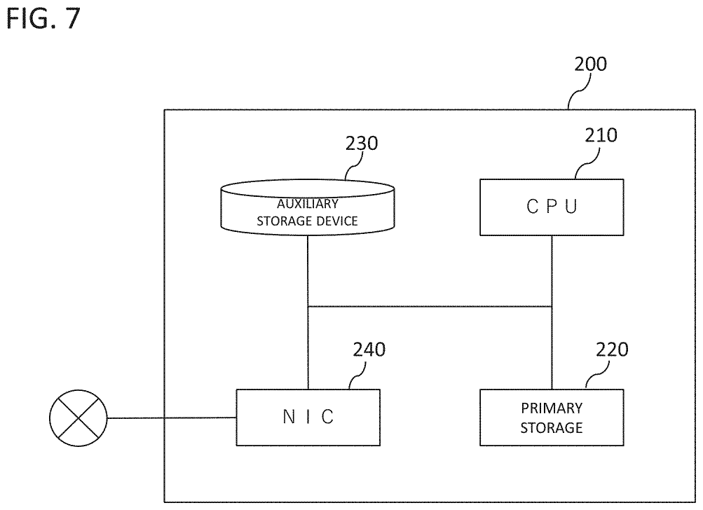

FIG. 7 is a drawing illustrating an example of the hardware configuration of the management server 200. The management server 200 described above may be configured as an information processing apparatus having the hardware configuration shown in FIG. 7. It should be noted that the hardware configuration shown in FIG. 7 is merely an example of the hardware configuration realizing the function of the management server 200 and is not intended to limit the hardware configuration of the management server 200. Neither is a hardware configuration for realizing the cable connection work support method of the present example embodiment as a cable connection work support method limited to the hardware configuration shown in FIG. 7. The management server 200 may include hardware not shown in FIG. 7.

As shown in FIG. 7, the hardware configuration of the management server 200 comprises a CPU (Central Processing Unit) 210, a primary storage device 220, an auxiliary storage device 230, and a NIC (Network Interface Card) 240, which is a communication interface. These elements are connected to each other by, for instance, an internal bus.

The CPU 210 executes the cable connection work support program executed by the management server 200. The primary storage device 220 is, for instance, a RAM (Random Access Memory) and temporarily stores the cable connection work support program executed by the management server 200 so that the CPU 210 can process it.

The auxiliary storage device 230 is, for instance, an HDD (Hard Disk Drive) and is capable of storing the cable connection work support program executed by the management server 200 in the medium to long term. The cable connection work support program may be provided as a computer program stored in a non-transitory computer-readable storage medium. The auxiliary storage device 230 can be used to store the cable connection work support program stored in a non-transitory computer-readable storage medium over the medium to long term.

The NIC 240 provides an interface to an external terminal via a network. The NIC 240 is used to receive an image of the surface pattern of an end of the cable to be connected and images of the host name and a port of an apparatus or to transmit the work support information based on the result of individual product identification.

### Second Example Embodiment

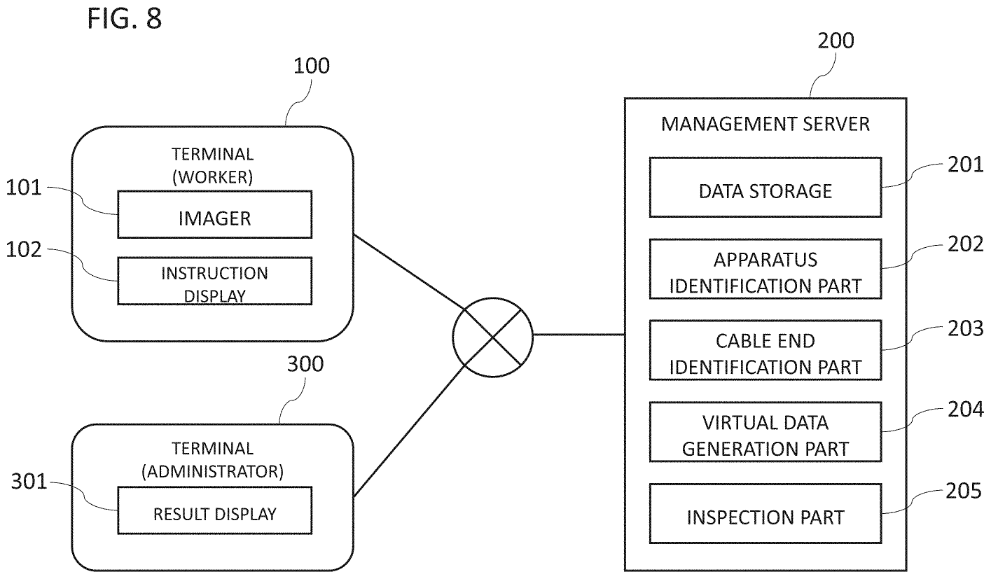

FIG. 8 is a schematic diagram of a cable connection work support system relating to a second example embodiment. As shown in FIG. 8, the cable connection work support system relating to the second example embodiment comprises the terminal 100, the management server 200, and a terminal 300.

The terminal 100 used by the worker comprises an imager 101 and an instruction display 102. Meanwhile, the management server 200 comprises a data storage 201, an apparatus identification part 202, a cable end identification part 203, a virtual data generation part 204, and an inspection part 205. Further, the terminal 300 used by an administrator comprises a result display 301.

For instance, the terminal 100 used by the worker may be a mobile terminal such as smart glasses, a smartphone or tablet supporting AR technology. The imager of the terminal 100 is used to capture an image of an end of the cable to be connected. Meanwhile, the instruction display 102 of the terminal 100 virtually displays the work support information received from the management server 200 on the image of the cable end using AR technology and presents it to the worker.

The data storage 201 in the management server 200 stores the cable connection design information (cable accommodation list) L that includes information pairing the surface patterns of both ends of a cable and information pairing the ports of apparatuses to be connected.

The apparatus identification part 202 identifies an apparatus to be connected by the worker. Here, an apparatus may be a server or hub. For instance, the apparatus identification part 202 may identify an apparatus to be connected by the worker by performing individual product identification on the basis of the surface pattern of the apparatus without excluding the possibility that the worker transmits identification information to the apparatus identification part 202 by operating the terminal 100. Further, it is also possible to use information such as how many ports the apparatus to be connected has, how the ports are arranged, port numbers, the dimensions and shape of the apparatus, and the position of the ports on the apparatus. The information of the apparatus identified by the apparatus identification part 202 is used to search the cable connection design information (cable accommodation list) L.

The cable end identification part 203 performs individual product identification on a cable on the basis of the surface pattern of an end of the cable received from the terminal 100. Here, the individual product identification based on the surface pattern is an identification method for matching the surface pattern specific to an individual product that inevitably occurs during the process of manufacturing the product.

This technology is also known as, for instance, “object fingerprint authentication”. The surfaces of mass-produced products are supposed to be processed uniformly during the manufacturing process, however, minute differences between the surfaces of individual items are inevitable. The object fingerprint authentication is a technology for matching minute differences between individual products in the same manner as fingerprint authentication. The cable end identification part 203 collates the surface pattern of the cable end received from the terminal 100 with the surface pattern of a cable end stored in the data storage 201 and searches for the work support information such as information of the port of the apparatus to which the cable end is to be connected and information of the port of the apparatus to which the other end is connected.

It should be noted that the surface pattern of a cable end is not limited to surface patterns that inevitably occur during the manufacturing process and includes the results of processing intentionally increasing individual product differences such as applying paint or a matte finish after manufacturing.

The virtual data generation part 204 generates the work support information as visible virtual information based on the results identified by the apparatus identification part 202 and the cable end identification part 203. This visible virtual information is created over the image captured by the imager 101 of the terminal 100 and displayed on the instruction display 102 of the terminal 100. As the work support information, for instance, a virtual cable tag may be displayed near the end of the cable, and the connection destination of the cable may be displayed on this cable tag.

The inspection part 205 confirms that the cable is correctly connected to the port, looking at an image of the cable end and the port of the apparatus after the connection work. More specifically, the apparatus identification part 202 identifies the apparatus and the port from the image of the cable end and the port of the apparatus after the connection work. Meanwhile, the cable end identification part 203 identifies the cable from the image of the cable end and the port of the apparatus after the connection work. The inspection part 205 determines whether or not these identification results match the cable connection design information (cable accommodation list) L stored in the data storage 201.

The result display 301 of the terminal 300 is a display device for displaying the result of connection correctness determined by the inspection part 205 of the management server 200. In general, a plurality of workers simultaneously performs cable connection work in large-scale system construction. Also, in large-scale system construction, a cable may be connected from one room or building to another that is far away. The terminal 300 used by the administrator can centrally manage these dispersed connection operations in real time.

In addition, the terminal 300 also contributes to improving the work efficiency of finished work inspection. As described above, in finished work inspection using physical markings such as cable tags, the cable connection design information (cable accommodation list) L is visually compared with the physical markings such as cable tags. In the present example embodiment, the result display 301 of the terminal 300 displays whether or not a cable is correctly connected to a port, improving the work efficiency of finished work inspection and the inspection quality greatly.

Next, a mode of use of the present example embodiment will be described in detail.

### 1) Preliminary Preparation

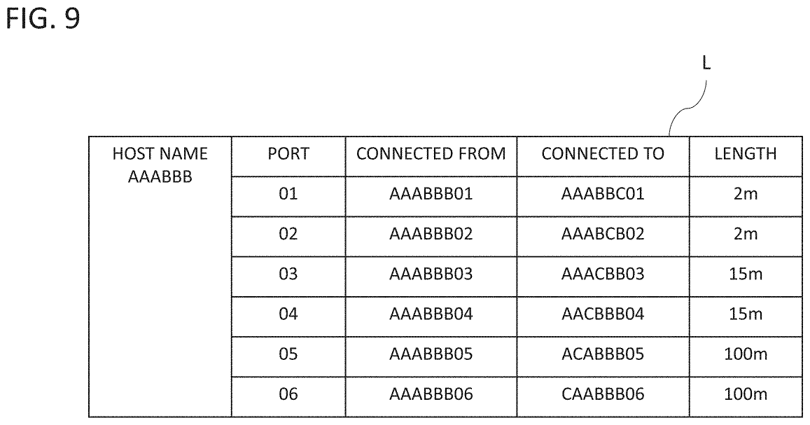

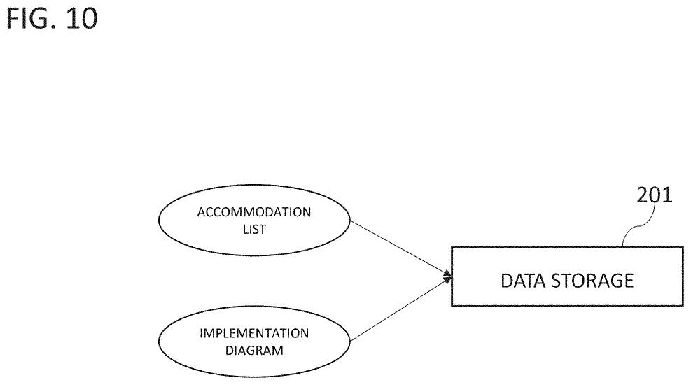

Before the cable connection work, the data storage 201 of the management server 200 stores data such as the cable connection design information (cable accommodation list) L shown in FIG. 9 and an implementation diagram of the apparatus. FIG. 10 is a drawing showing the flow of information until the cable accommodating list and the implementation diagram of the apparatus are stored in the data storage 201.

Further, as a preliminary preparation for on-site work, when the number of cables is verified (the number of cables received is confirmed for each length), the required number of cables are prepared for each length as indicated for each connection port number on the cable connection design information (cable accommodation list) L.

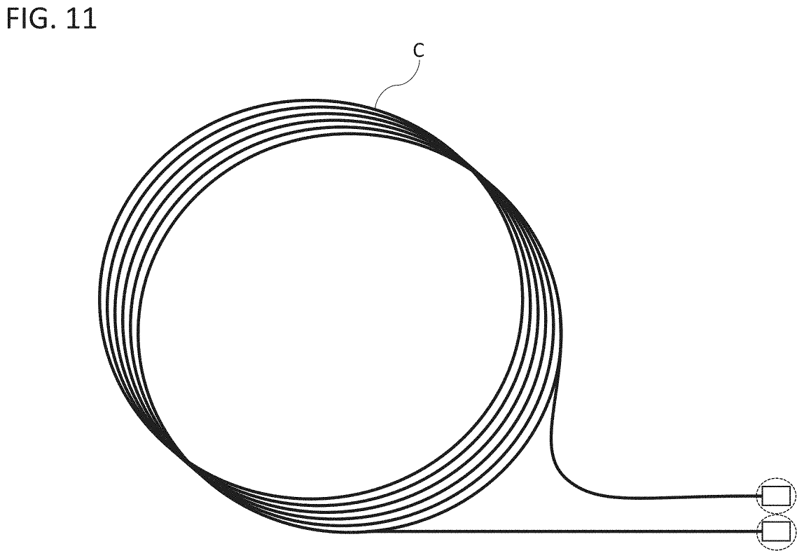

Then, as shown in FIG. 11, using a device such as a camera, images of the surface patterns of both ends of each cable C, with the images of the two ends of the cable C paired, are acquired. FIG. 11 indicates the areas where the images should be taken with broken lines. For instance, the imager 101 of the terminal 100 may be used to acquire the images of the surface patterns of both ends of each cable.

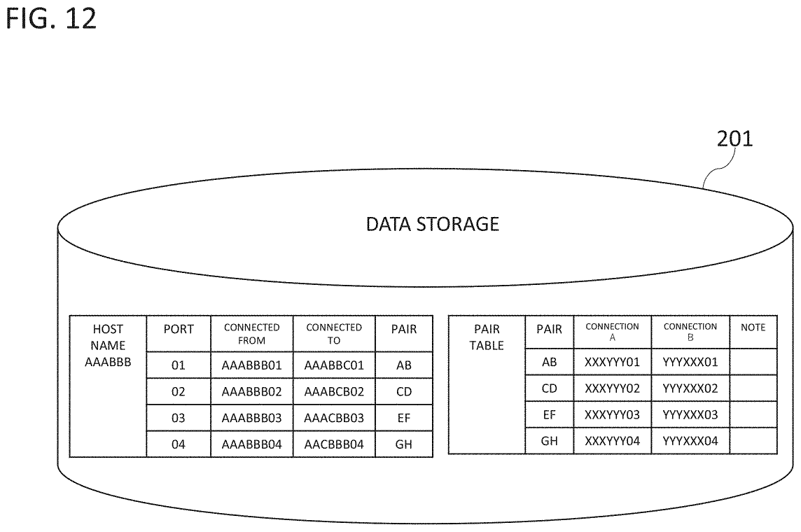

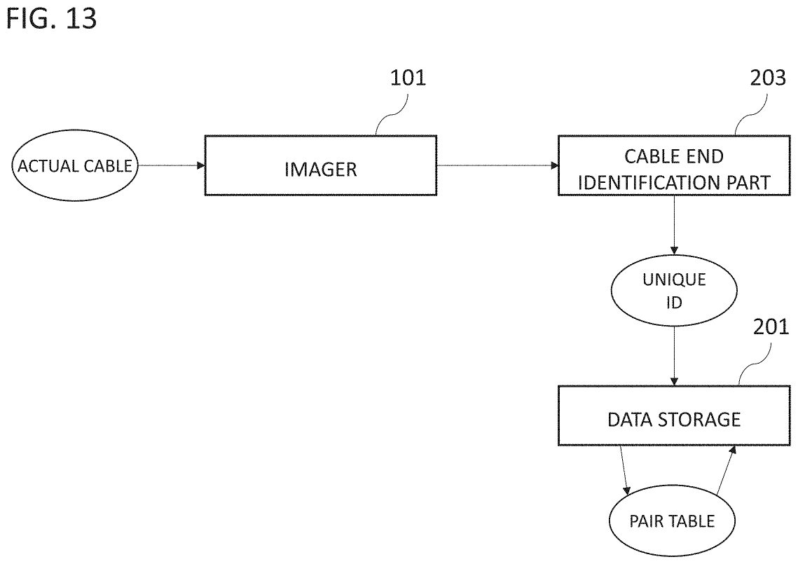

The cable end identification part 203 of the management server 200 analyzes the images of the surface patterns of both ends of each cable, extracts individually identifiable features, and then stores the individually identifiable features of the surface patterns of both ends of each cable in the data storage 201 as unique IDs. At this time, the relationship between both ends of a cable is registered by pairing the unique IDs of the two ends of a cable. For instance, as shown in FIG. 12, the relationships of both ends of cables are stored as a pair table in the data storage 201. Then, the cable pair number of a cable to be connected to the corresponding connection port is registered in the cable connection design information (cable accommodation list) L. FIG. 13 is a drawing showing the flow of information until the pair table is stored.

For instance, the cable end identification part 203 preferably comprises a pair mode capable of processing two cable ends as a pair (both ends of a cable). More specifically, upon acquiring an image of a cable end, the cable end identification part 203 enters this pair mode and processes an image of a cable end subsequently acquired as an image of both ends of one cable. This operation associates the two cable ends as both ends of the same cable. Further, a plurality of surface pattern images may be used for each cable end in order to improve the accuracy of individual product identification.

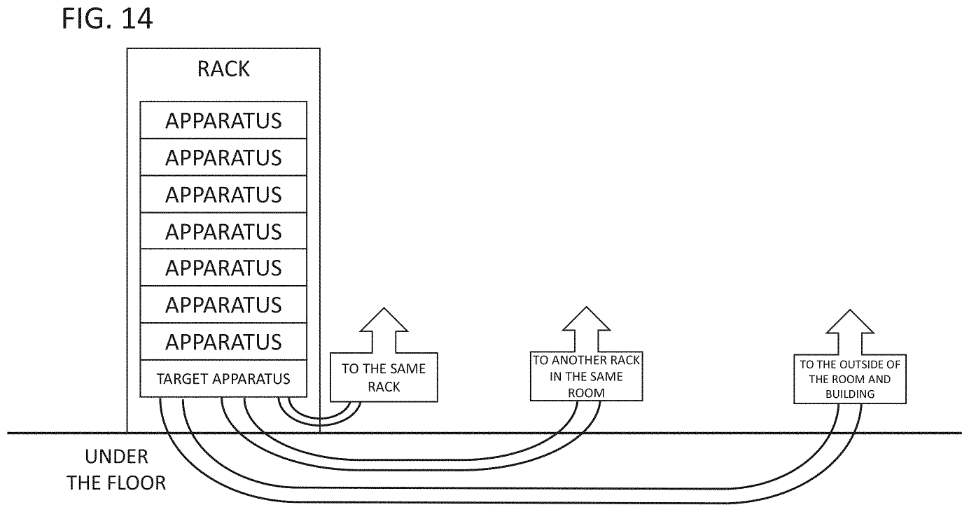

As shown in FIG. 14, cables are laid under the floor for each rack housing a target apparatus and connected to each apparatus.

### 2) Navigation (Work Support)

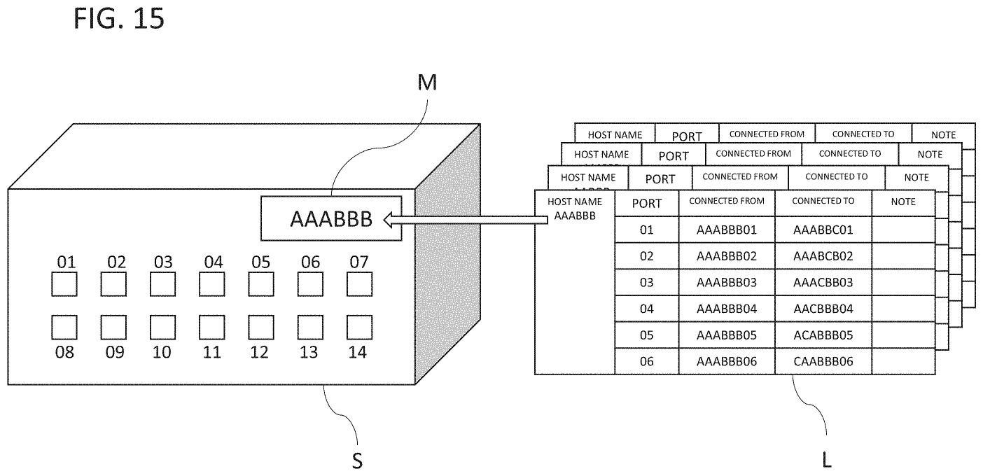

The apparatus identification part 202 of the management server 200 acquires an image of the ports of an apparatus captured by the imager 101 of the terminal 100 via a network and identifies the name (host name) of the apparatus from the image. The apparatus identification part 202 searches for an apparatus name (host name) that corresponds to features extracted from the image in the cable connection design information (cable accommodation list) L stored in the data storage 201. As shown in FIG. 15, the virtual data generation part 204 generates marking data for the searched apparatus host name and displays the marking M denoting the target apparatus superimposed over an image of the actual apparatus S using the instruction display 102.

The apparatus identification part 202 acquires the image of the ports of the apparatus S via a network and recognizes the width and the height of the apparatus S. Further, on the basis of the port shape learned in advance, the apparatus identification part 202 recognizes the number of ports, the number of port arrays, and the distances from the top, bottom, left, and right corners of the apparatus S from the image and obtains information of relative locations of the ports. The apparatus identification part 202 further recognizes the port numbers from what is displayed above or below the ports.

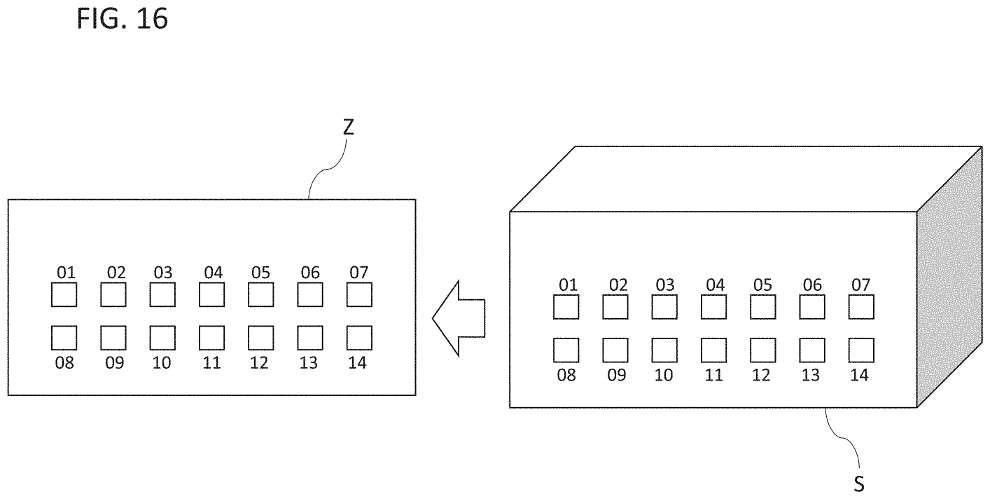

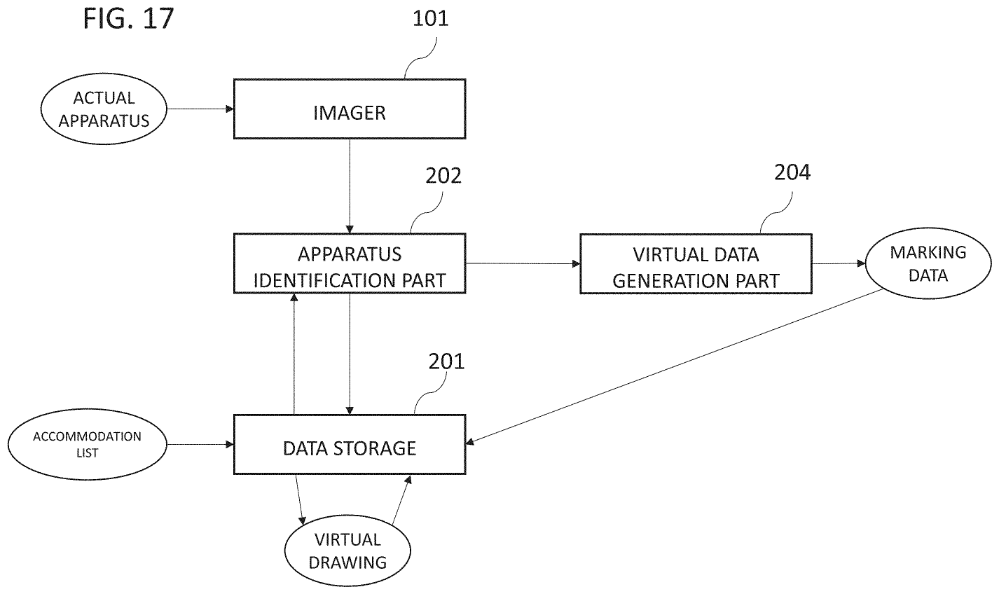

As shown in FIG. 16, the apparatus identification part 202 generates data of a virtual drawing Z for each apparatus on the basis of the extracted and recognized information and stores the data in the data storage 201. FIG. 17 is a drawing showing the flow of information until the data of the virtual drawing is stored in the data storage 201.

The apparatus identification part 202 acquires the image of the ports of an apparatus captured by the imager 101 of the terminal 100 via a network, extracts the host name of the apparatus, and extracts the relevant data on the basis of the host name information from the cable connection design information (cable accommodation list) L stored in the data storage 201.

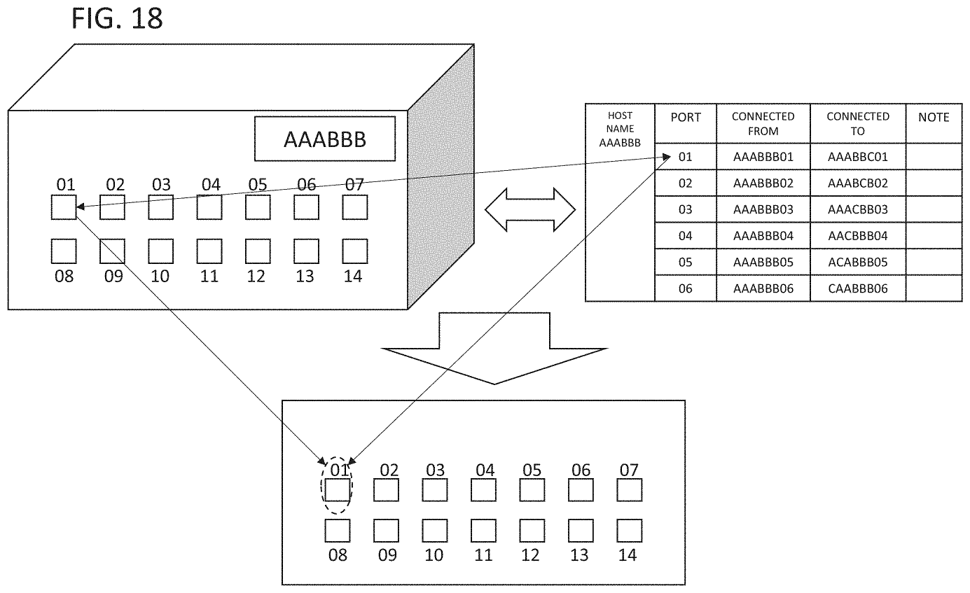

As shown in FIG. 18, the virtual data generation part 204 generates virtual marking data for the relevant port from the port information in the cable connection design information (cable accommodation list) L of the extracted relevant host name. Then, the virtual data generation part 204 generates the virtual marking data over the location of the cable port and the port description in the virtual drawing stored in the data storage 201 and stores the virtual marking data in the data storage 201 along with the virtual drawing.

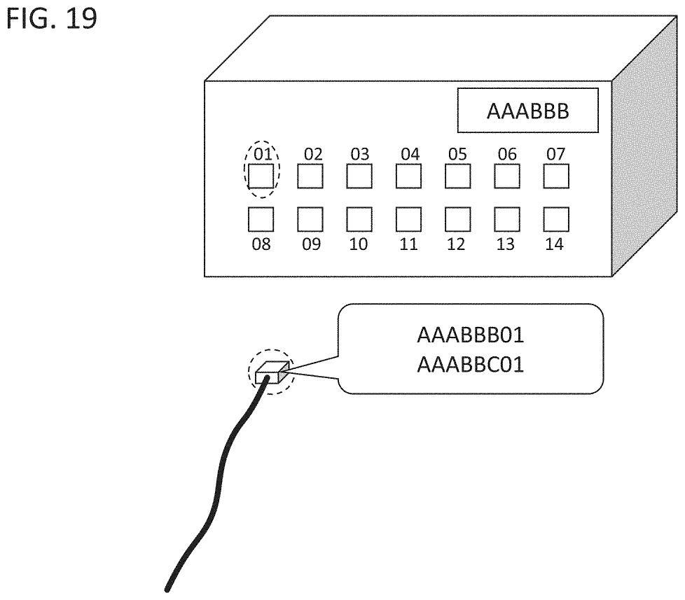

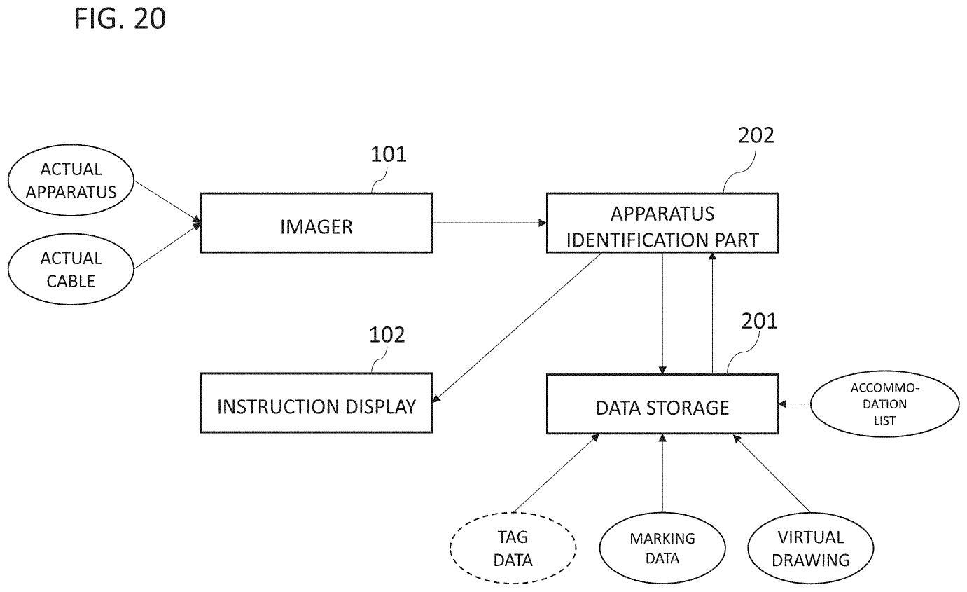

Meanwhile, as shown in FIG. 19, the instruction display 102 of terminal 100 displays the virtual marking data superimposed over the apparatus S on the basis of the relevant virtual drawing data stored in the data storage 201 and the location in the virtual marking information stored in the data storage 201. FIG. 20 is a drawing showing the flow of information until the virtual marking data is displayed.

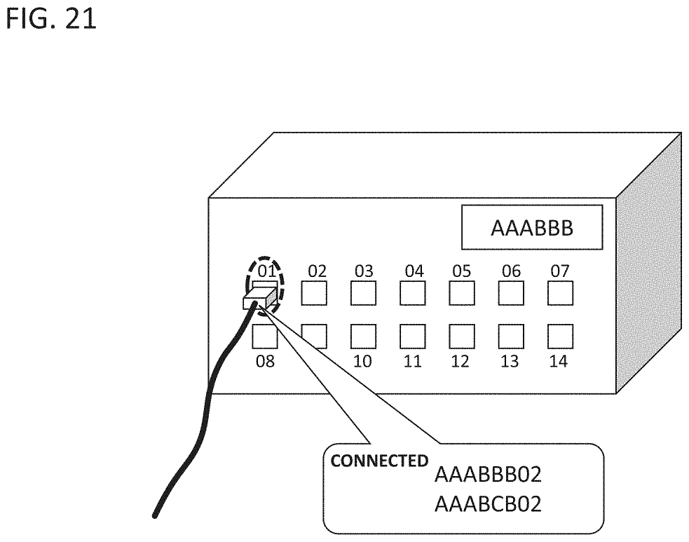

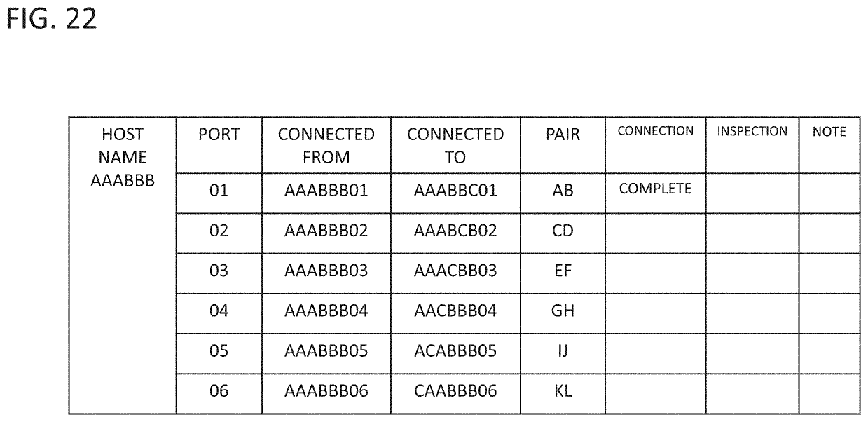

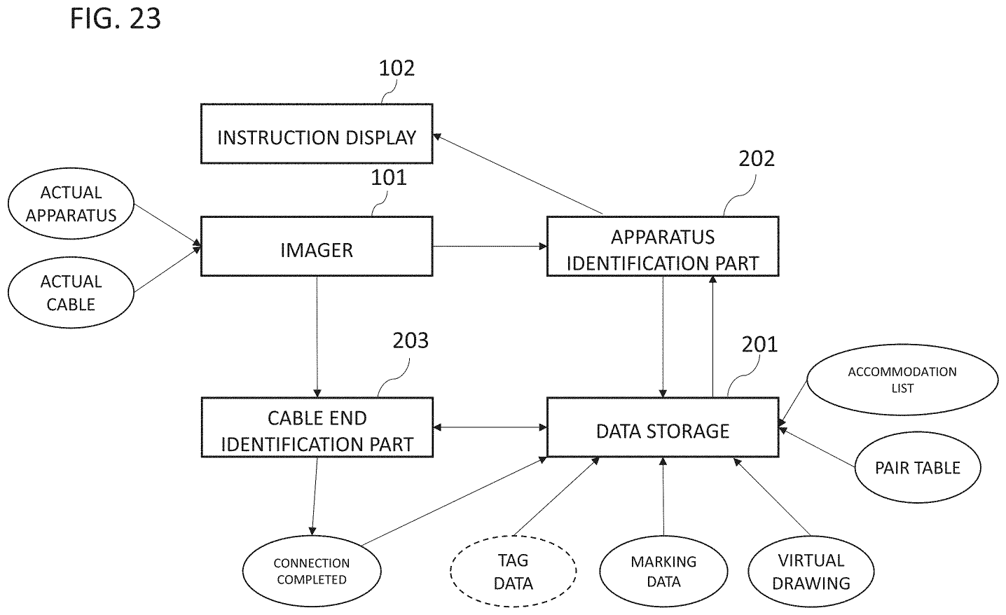

After the cable has been actually connected, an image of the cable end connected to the port of the apparatus is taken using the imager 101 of the terminal 100. The apparatus identification part 202 identifies the apparatus (host name) from the image acquired via a network. Meanwhile, the end identification part 203 identifies the cable end from the image acquired via a network. Then, as shown in FIG. 21, the worker confirms that the cable is correctly connected according to the support information displayed on the instruction display 102. Next, as shown in FIG. 22, information indicating connection completion is added to the cable connection design information (cable accommodation list) L. FIG. 23 is a drawing showing the flow of information until the information of connection completion is registered.

### 3) Finished Work Inspection

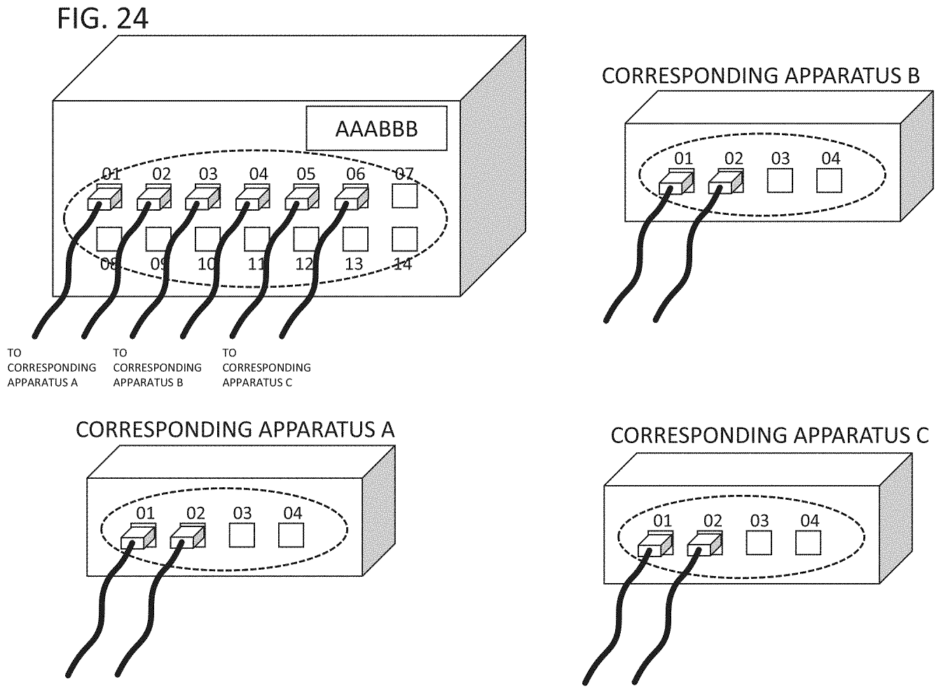

During the finished work inspection, the imager 101 of the terminal 100 is used to capture an image showing how the cables are connected to all the target ports of the target apparatus, as shown in FIG. 24. When a “finished work inspection” function of the inspection part 205 in the management server 200 is executed, the apparatus identification part 202 acquires the image data via a network, extracts the host name of the target, and extracts the cable accommodation list with the corresponding apparatus name using the host name from the cable connection design information (cable accommodation list) L stored in the data storage 201.

Meanwhile, the cable end identification part 203 identifies the cable end from the image acquired via a network. Then, the inspection part 205 verifies the cable connection design information (cable accommodation list) L stored in the data storage 201 and the identification result.

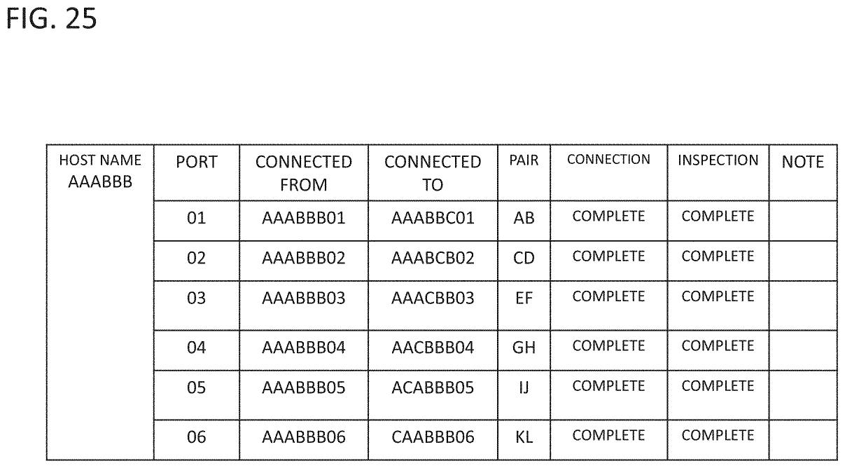

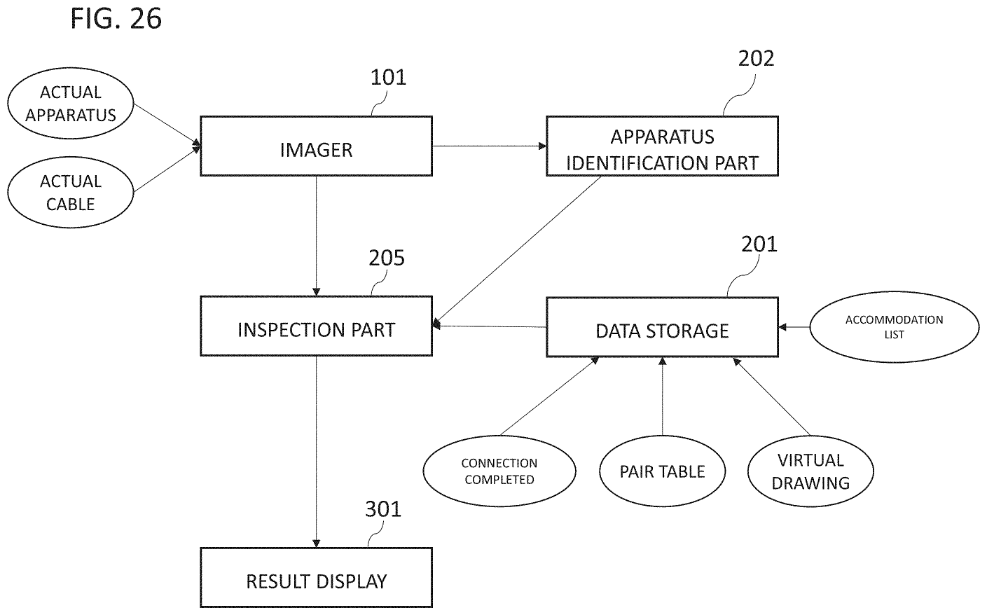

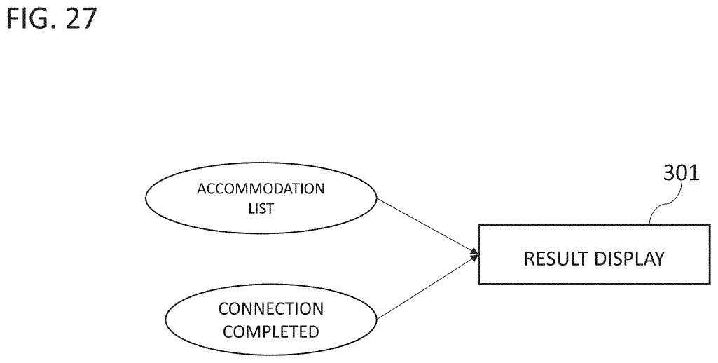

Then, as shown in FIG. 25, the inspection part 205 adds the inspection results to the cable connection design information (cable accommodation list) L stored in the data storage 201. FIG. 26 is a drawing showing the flow of information until the inspection results are added to the cable accommodation list. Further, the inspection part 205 transmits the inspection results to the terminal 300, and the result display 301 displays the inspection results. FIG. 27 is a drawing showing the flow of information until the inspection results are displayed.

### Modified Example Embodiments

The following describes several modified example embodiments.

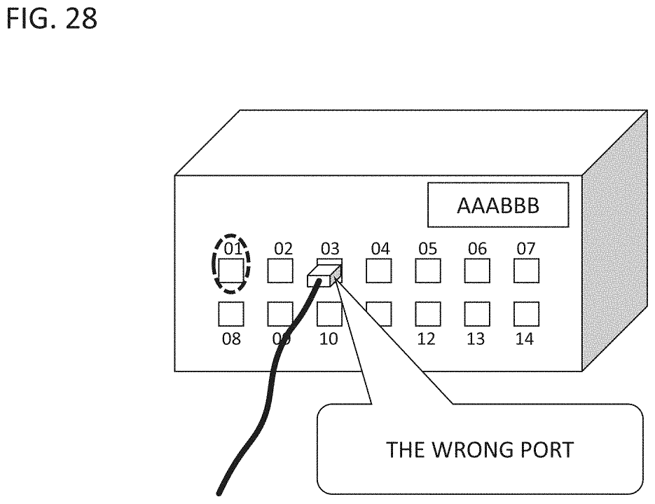

In a first modified example embodiment, when the worker attempts to connect a cable to the wrong port, a warning is given to the worker with a message, sound, blinking light, or vibration on the AR screen of the terminal 100, as shown in FIG. 28.

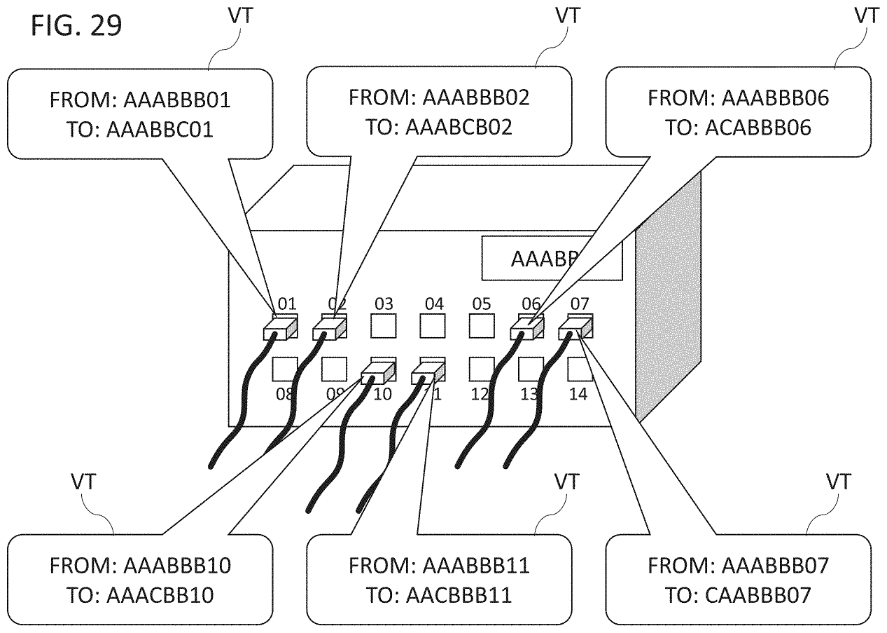

In a second modified example embodiment, round tag information is also virtualized, as shown in FIG. 29. In the present modified example embodiment, the virtual data generation part 204 generates virtual cable tag (round tag) VT information from the relevant port information in the cable connection design information (cable accommodation list) L in the data storage 201. Then, the instruction display 102 of the terminal 100 displays the virtual cable tag (round tag) VT information.

The cable tag (round tag) T, which is a physical identification marking, may get entangled with another cable due to the wind from equipment. Further, the worker may accidentally pull the round tags of cables that he is not working on, interrupting services running on those cables. Moreover, there is the risk of mistakes such as maintenance workers/operators misunderstanding the tags or workers from a company different from the one who constructed the system misinterpreting the tags due to a different description system. The possibility of these risks is mitigated since the round tag information is also virtualized in the second modified example embodiment.

A third modified example embodiment is an example embodiment that can also be utilized when the configuration of a system is changed. In other words, when a system configuration is changed, the instruction display 102 of the terminal 100 indicates a cable to be disconnected and marking information guides the worker to the port to which the disconnected cable is to be connected.

In order to achieve this, the information of each connection source and destination is updated in the cable connection design information (cable accommodation list) L in advance. Further, in a case of an active cable system, it is necessary to specify the work order for safety, and one marking is displayed at a time according to the work order registered in advance. When a disconnected cable needs to be plugged into a different apparatus, the host name of the target apparatus may be displayed to guide the worker to the apparatus.

In a fourth modified example embodiment, the cable connection status is shared (displayed/viewed) by the workers. In cable connection work for large-scale system construction, a plurality of workers needs to work simultaneously at a plurality of sites and cooperate with each other. For instance, the work order may be specified such as when, at one site, work cannot be commenced until a cable is connected to a specific port at another. In the fourth modified example embodiment, the management server 200 manages work order information, hiding markings when work should not be started or showing a “standby” display to make the worker wait. When work at a first site is completed and another at a second site can commence, marking data automatically gives work permission, enabling the workers to reliably cooperate without calling each other constantly.

In a fifth modified example embodiment, the result of an end-to-end continuity check is stored when physical cable connection is completed. In normal construction, the workers simply connect cables physically and a continuity check is carried out during the subsequent network connection work. In the fifth modified example embodiment, a continuity check is performed after the cable connection work is done, the status thereof is captured and judged using an image, and the result of the continuity check is stored in the table along with other information.

Further, in each example embodiment of the present invention, remote management is possible since the cable connection status can be saved in a timely manner, and the present invention can be utilized for remote education or for on-the-job training because the cable connection status can be shared in a visually lucid manner. Moreover, the present invention can be utilized not only for LAN cable connection work, but also for power system cable connection and distribution board work, quality improvement by removing cables, the elimination of work mistakes, and inspection streamlining.

While each example embodiment of the present invention has been described, it is to be noted that it is possible to modify or adjust the example embodiments or examples within the whole disclosure of the present invention (including the Claims) and based on the basic technical concept thereof. Further, it is possible to variously combine or select (or at least partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. Further, the disclosure of each Patent Literature cited above is incorporated herein in its entirety by reference thereto.

### REFERENCE SIGNS LIST

100: terminal
101: imager
102: instruction display
200: management server
201: data storage
202: apparatus identification part
203: cable end identification part
204: virtual data generation part
205: inspection part
210: CPU
220: primary storage device
230: auxiliary storage device
240: NIC
300: terminal
301: result display
C: cable
M: marking
P: temporary marking
S: apparatus
Z: virtual drawing
P1 to P5: person

What is claimed is:

1. A cable connection work support system comprising:
a terminal that takes an image of an end of a cable to be connected; and
a management server that performs individual product identification on the basis of a pattern on the surface of the end of the cable photographed by the terminal and transmits work support information based on the result of the individual product identification to the terminal.

2. The cable connection work support system according to claim 1, wherein the terminal comprises a display that presents the work support information to a worker by virtually displaying the work support information on the image of the end of the cable.

3. The cable connection work support system according to claim 1, wherein the work support information includes information of a port of an apparatus to which the end of the cable is to be connected.

4. The cable connection work support system according to claim 1, wherein the work support information includes information of a port of an apparatus to which the other end of the cable is connected.

5. The cable connection work support system according to claim 1, wherein
the terminal captures an image of a cable end and a port of an apparatus after connection work, and
the management server determines whether the connection is correctly made on the basis of the image of the cable end and the port of the apparatus captured by the terminal.

6. The cable connection work support system according to claim 5 further comprising a management terminal that displays the result of connection correctness determined by the management server.

7. The cable connection work support system according to claim 1, wherein the management server stores cable connection design information that includes information pairing the surface patterns of both ends of the cable and information pairing the ports of the apparatuses to be connected.

8. The cable connection work support system according to claim 1, wherein the individual product identification based on the surface pattern is performed by matching the surface pattern specific to an individual product that inevitably occurs during the process of manufacturing the product.

9. A cable connection work support method including:
performing individual product identification on the basis of a pattern on the surface of a cable end photographed by a worker who performs connection work; and
presenting work support information based on the result of the individual product identification to the worker.

10. A non-transient computer readable medium storing a cable connection work support program causing a computer to: execute processes of:
receiving an image of the surface pattern of an end of a cable to be connected;
performing individual product identification on the basis of the surface pattern of the cable end; and
transmitting work support information based on the result of the individual product identification.

11. The cable connection work support method according to claim 9, including:
presenting the work support information to a worker by virtually displaying the work support information on the image of the end of the cable.

12. The cable connection work support method according to claim 9, wherein the work support information includes information of a port of an apparatus to which the end of the cable is to be connected.

13. The cable connection work support method according to claim 9, wherein the work support information includes information of a port of an apparatus to which the other end of the cable is connected.

14. The cable connection work support method according to claim 9, including:
capturing an image of a cable end and a port of an apparatus after connection work; and
determining whether the connection is correctly made on the basis of the image of the cable end and the port of the apparatus.

15. The cable connection work support method according to claim 9, wherein the individual product identification based on the surface pattern is performed by matching the surface pattern specific to an individual product that inevitably occurs during the process of manufacturing the product.

16. The non-transient computer readable medium storing the cable connection work support program according to claim 10, causing the computer to execute a process of:
presenting the work support information to a worker by virtually displaying the work support information on the image of the end of the cable.

17. The non-transient computer readable medium storing the cable connection work support program according to claim 10, wherein the work support information includes information of a port of an apparatus to which the end of the cable is to be connected.

18. The non-transient computer readable medium storing the cable connection work support program according to claim 10, wherein the work support information includes information of a port of an apparatus to which the other end of the cable is connected.

19. The non-transient computer readable medium storing the cable connection work support program according to claim 10, causing the computer to execute processes of:
capturing an image of a cable end and a port of an apparatus after connection work; and
determining whether the connection is correctly made on the basis of the image of the cable end and the port of the apparatus.

20. The non-transient computer readable medium storing the cable connection work support program according to claim 10, wherein the individual product identification based on the surface pattern is performed by matching the surface pattern specific to an individual product that inevitably occurs during the process of manufacturing the product.
